(19) United States
(12) Patent Application Publication
(10) Pub. No.: US 2008/0078563 A1
(43) Pub. Date: Apr. 3, 2008

(54) Oxygen absorbing fire suppression system

(75) Inventors: Quek-Cheng Hock, Singapore (SG); Thomas Leonhardt, Schiffenstadt (DE); Guobi Zhang, Marinette, WI (US)

Correspondence Address: Gerald Bluhm;Tyco Fire and Security, 50 Technology Drive, Westminster, MA, 01441, US

(73) Assignee: ANSUL, INC.

(21) Appl. No.: 11/541,743

(22) Filed: Oct. 2, 2006

(51) Int. Cl. A62C 8/00

(52) U.S. Cl. 169/49

(57) ABSTRACT

An oxygen absorbing fire suppression system comprises oxygen absorbing material for absorbing oxygen from ambient air within an enclosed space. A housing prevents the oxygen absorbing material from exposure to the ambient air outside the housing. The housing has at least one opening for exposing the oxygen absorbing material to the ambient air, and at least one seal is provided proximate the at least one opening to prevent the oxygen absorbing material from exposure to the ambient air. An actuating component removes at least a portion of the at least one seal to expose the oxygen absorbing material to the ambient air. The oxygen absorbing material is configured to lower an oxygen concentration within the enclosed space to a level that extinguishes fire.

### BACKGROUND OF THE INVENTION

This invention relates generally to fire suppression systems, and more particularly, to extinguishing systems used to reduce the level of oxygen within an enclosed space.

Fire protection systems are used to suppress and/or extinguish a fire within an enclosed area. For example, inert gas extinguishing systems use inert gas to reduce the level of oxygen in the ambient air within the enclosed area or other contained space. Typical ambient air may have an oxygen level of around 21%. When the oxygen concentration is reduced to below 15%, combustion is not supported and fire is suppressed. Inert gas extinguishing systems are often used in enclosed spaces like office buildings, computer rooms, and the like as humans can breathe normally when the oxygen concentration is at 12.5% or above.

One way of reducing the concentration of oxygen in an enclosed space is to dilute the oxygen by adding a large quantity of inert gas, such as nitrogen, argon or carbon dioxide, to the space. The inert gas mixes with the ambient air and dilutes the oxygen percentage. One disadvantage of this type of system is that a large amount of inert gas is needed, which requires many pressurized cylinders to be stored. For example, to reduce the oxygen concentration from 21% to a range of 15% to 13%, which is a 6% to 8% reduction, a volume of inert gas of between 34% and 42% of the total air volume of the room is pumped into the room. As the pressure within the room increases due to the addition of the inert gas, the mixture of ambient air and inert gas will escape through cracks and vents in the room, which may negatively impact the quantity of inert gas and may allow reflare, in addition to potentially forcing the release of toxic fumes into neighboring compartments. Also, the pressure within the room has to be limited to avoid damage to structures such as walls and windows.

Therefore, a need exists for a fire extinguishing system that provides fire suppression to an enclosed space while minimizing or eliminating the quantity of inert gas needed and which does not create a large pressure within the enclosed space. Certain embodiments of the present invention are intended to meet these needs and other objectives that will become apparent from the description and drawings set forth below.

### BRIEF DESCRIPTION OF THE INVENTION

In one embodiment, an oxygen absorbing fire suppression system comprises oxygen absorbing material for absorbing oxygen from ambient air within an enclosed space. A housing prevents the oxygen absorbing material from exposure to the ambient air outside the housing. The housing has at least one opening for exposing the oxygen absorbing material to the ambient air, and at least one seal is provided proximate the at least one opening to prevent the oxygen absorbing material from exposure to the ambient air. An actuating component removes at least a portion of the at least one seal to expose the oxygen absorbing material to the ambient air. The oxygen absorbing material is configured to lower an oxygen concentration within the enclosed space to a level that extinguishes fire.

In another embodiment, a method for extinguishing a fire within an enclosed space comprises providing oxygen absorbing material within a housing that has at least one opening provided with a seal. The housing and seal prevent the oxygen absorbing material from exposure to ambient air within an enclosed space. The at least one opening within the housing is opened to expose the oxygen absorbing material to the ambient air within the enclosed space. The oxygen absorbing material absorbs the oxygen from the ambient air within the enclosed space. The oxygen absorbing material is configured to lower an oxygen concentration within the enclosed space to a level that extinguishes fire.

In another embodiment, a system for replacing oxygen with an inert gas within an enclosed space comprises oxygen absorbing material for absorbing oxygen from ambient air within an enclosed space. The oxygen absorbing material is configured to lower an oxygen concentration within the enclosed space to a level that extinguishes fire. An oxygen absorber unit holds the oxygen absorbing material and has an air inlet allowing ambient air to enter the oxygen absorber unit and an air outlet for outputting oxygen-reduced air. The air inlet and air outlet are interconnected with the enclosed space. Means for preventing the ambient air and oxygen absorbing material from being in contact with one another is provided, as well as means for pulling ambient air into the oxygen absorber unit through the air inlet from the enclosed space.

### BRIEF DESCRIPTION OF THE DRAWINGS

FIG. 1 illustrates an alarm system formed in accordance with an embodiment of the present invention.

FIG. 2 illustrates an oxygen absorber system used to provide fire suppression within an enclosed space in accordance with an embodiment of the present invention.

FIG. 3 illustrates an oxygen absorber system having an inert gas cylinder held at a location away from an oxygen absorber unit and the enclosed space in accordance with an embodiment of the present invention.

FIG. 4 illustrates an alternative oxygen absorber system installed within the enclosed space in accordance with an embodiment of the present invention.

FIG. 5 illustrates a view of an inert gas cylinder and absorber housing inside an oxygen absorber unit in accordance with an embodiment of the present invention.

FIG. 6 illustrates a view of the outside of the oxygen absorber unit of FIG. 5 in accordance with an embodiment of the present invention.

FIG. 7 illustrates a cut-away view of a rotatable structure within of the absorber housing of FIG. 5 in accordance with an embodiment of the present invention.

FIG. 8 illustrates a cut-away view of a portion of the shaft within the rotatable structure of FIG. 7 in accordance with an embodiment of the present invention.

FIG. 9 illustrates an alternative oxygen absorber system formed in accordance with an embodiment of the present invention.

FIG. 10 illustrates an oxygen absorber system which does not use pressurized inert gas formed in accordance with an embodiment of the present invention.

FIG. 11 illustrates an alternative oxygen absorber system which does not use pressurized inert gas formed in accordance with an embodiment of the present invention.

The foregoing summary, as well as the following detailed description of certain embodiments of the present invention, will be better understood when read in conjunction with the appended drawings. The figures illustrate diagrams of the functional blocks of various embodiments. The functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

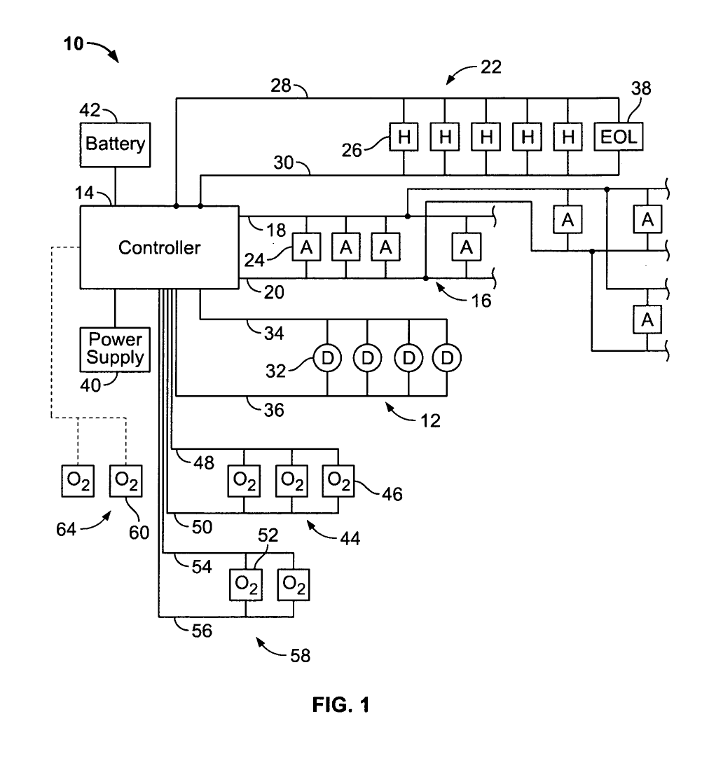

FIG. 1 illustrates an alarm system 10. The system 10 includes one or more detector networks 12 having individual alarm condition detectors 32 which are monitored and controlled by a controller 14 or control panel. The detectors 32 may detect fire, smoke, temperature, chemical compositions, or other conditions. The alarm condition detectors 32 are coupled across a pair of power lines 34 and 36. When an alarm condition is sensed, the controller 14 signals the alarm to the appropriate notification devices and fire suppression devices through one or more networks 16 of addressable notification appliances 24, networks 22 of hardwired (e.g. non-addressable) notification appliances 26, and networks 44, 58 and 64 of oxygen absorber systems 46, 52 and 60, respectively.

The controller 14 is connected to a power supply 40 which provides one or more levels of voltage to the system 10. The power supply 40 may be an AC branch circuit. One or more batteries 42 provide a back-up power source for a predetermined period of time in the event of a failure of the power supply 40 or other incoming power. Functions of the controller 14 include displaying the status of the system 10 and/or installed components, resetting a part or all of the system 10, silencing signals, turning off strobe lights, and the like.

The addressable notification appliances 24 are coupled to the controller 14 across a pair of lines 18 and 20 that are configured to carry power and communications, such as command instructions. The notification appliances 24 may be wired in a fashion referred to as “T-Tapped”, forming multiple branches or spokes which may be tapped and run off in different directions. Supervision of the notification appliances 24 occurs by polling each notification appliance 24. The notification appliances 24 each have a unique address and both send and receive communications to and from the controller 14.

The hardwired notification appliances 26 are coupled with the controller 14 across a pair of lines 28 and 30. A notification signal sent on the network 22 from the controller 14 will be received by each hardwired notification appliance 26. An end of line (EOL) device 38, such as a resistor, interconnects the ends of the lines 28 and 30 opposite the controller 14.

The oxygen absorber systems 46 may be coupled with the controller 14 across a pair of lines 48 and 50. The oxygen absorber systems 46 may each have a unique address and both send and receive communications to and from the controller 14. An activation signal sent on the network 44 may thus activate only selected oxygen absorber system(s) 46. Alternatively, one or more oxygen absorber systems 52 may be installed on the network 58 across a pair of lines 54 and 56. An activation signal sent on the network 58 from the controller 14 will activate each oxygen absorber system 52. In another embodiment, one or more oxygen absorber systems 60 may be configured to communicate wirelessly with the controller 14. The oxygen absorber systems 60 may receive an activation signal from the controller 14 over a wireless network 64. One or more of the oxygen absorber systems 46, 52 and 60 may be self-contained units, having components, such as power supplies, separate from other components of the alarm system 10.

One oxygen absorber system configuration reduces the level of oxygen within an enclosed space by absorbing the oxygen from the ambient air. A negative or unbalanced pressure is created within the room. Clean air is pulled into the room through cracks, vents and the like, and thus smoke and noxious fumes are not pushed out of the room. In some situations, it may be desirable to have a system configuration that maintains a balanced pressure wherein the pressure is approximately the same inside and outside of the room. Therefore, another oxygen absorber system configuration may use a pressurized inert gas to dilute the volume of oxygen within an enclosed space while at the same time absorbing oxygen from the ambient air. Compared to systems which simply dilute the volume of oxygen with the inert gas, a more balanced air pressure is maintained inside the enclosed space, reducing the flow of air out of the room.

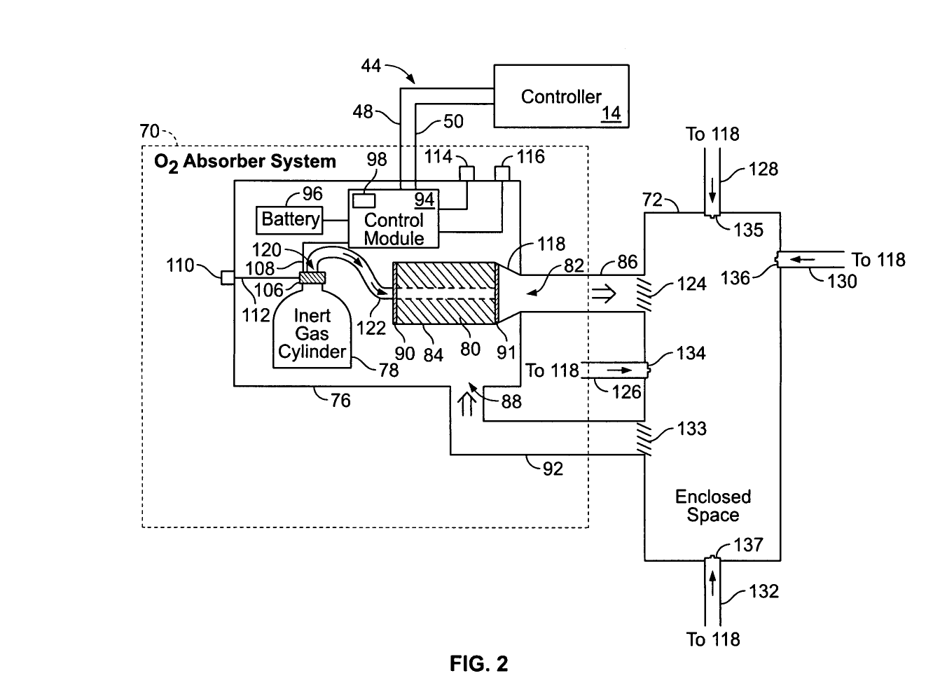

FIG. 2 illustrates an oxygen absorber system 70 used to provide fire suppression within enclosed space 72. The oxygen absorber system 70 absorbs oxygen from ambient air within the enclosed space 72 while replacing the oxygen with inert gas to a level that is still safe for humans, extinguishes fire and does not support combustion. The pressure within the enclosed space 72 is maintained at a level approximately the same as the pressure outside the enclosed space 72 to prevent air from being pushed out of or pulled into the enclosed space 72. The oxygen absorber system 70 is illustrated as being installed outside the enclosed space 72, and may alternatively be partially or completely installed inside the enclosed space 72. The oxygen absorber system 70 may be addressable, and thus capable of communication with the controller 14.

An oxygen absorber unit 76 encloses all or a part of the oxygen absorber system 70. The oxygen absorber unit 76 has at least one air outlet 82 connected to the enclosed space 72 with an outlet conduit 86, such as a hose or air duct. The oxygen absorber unit 76 has at least one air inlet 88 connected to the enclosed space 72 with an inlet conduit 92. Vents 124 and 133 may be provided at the enclosed space 72 end of the outlet and inlet conduits 86 and 92, respectively.

Alternatively, nozzles may be used to allow air flow in only one direction. Also, due to the shape, size and/or configuration of the enclosed space 72, it may be desirable to provide multiple inputs at different locations into the enclosed space 72. Therefore, multiple conduits, or first, second, third and fourth pipes 126, 128, 130 and 132 may replace the outlet conduit 86 and receive the air flow output of the absorber outlet 118. Each of the first, second, third and fourth pipes 126, 128, 130 and 132 may output air into the enclosed space 72 using first, second, third and fourth nozzles 134, 135, 136, and 137.

An inert gas cylinder 78 and oxygen absorbing material 80 are held within the oxygen absorber unit 76. The inert gas cylinder 78 holds inert gas under high pressure such as 150 bar (2175 psi) or 200 bar (2900 psi). The inert gas may be any single inert gas or combination of inert gases. For example, nitrogen, argon, carbon dioxide, other inert gas, or a blend of more than one inert gas may be used. The inert gas does not cause harm to humans and other animals and is both clean and environmentally friendly.

The oxygen absorbing material 80 is formed of one or more chemicals that absorb oxygen. The quantity and/or surface area of the oxygen absorbing material 80 may be determined based on at least one of the rate of the pressurized gas flow from the inert gas cylinder 78, the volume of the inert gas within the inert gas cylinder 78, volume of air within the enclosed space 72, rate at which oxygen absorption is desired, and a desired percentage of oxygen in the enclosed space 72. Therefore, the quantity and/or exposed surface of the oxygen absorbing material 80 can be changed based on fire protection requirements. The oxygen absorbing material 80 may be sealed within a housing 84, forming a barrier that prevents ambient air from contacting the oxygen absorbing material 80. For example, one or more seals 90 and 91 may be formed of foil or other puncturable material and integrated with the housing 84. The seals 90 and 91 may be punctured or blown off with a predetermined pressure, such as from the pressurized gas flow. Alternatively, the seals 90 and 91 may be mechanically punctured or removed, or may be formed as flaps.

A control module 94 may be located within the oxygen absorber unit 76 and receives communications and command instructions from the controller 14 (FIG. 1) over the lines 48 and 50, such as over the network 44. As previously discussed, multiple oxygen absorber systems 70 may be installed on the network 44. The control module 94 has control logic 98 that processes the command instructions and initiates desired action. The control module 94 may further comprise a microcontroller or microprocessor program execution. A battery 96 may be provided to supply back-up power to the control module 94. The battery 96 may also be used to operate a puncturing device (not shown) to puncture the seals 90 and 91 or an actuator or actuating component (not shown) to release a sealing flap, a valve (not shown) and the like.

The control module 94 monitors communications from the controller 14 for packets of information addressed to the oxygen absorber system 70. A packet of information may contain a command instruction to activate the oxygen absorber system 70, or may request a return status response. The control module 94 may reply to a status request by indicating a pressure level of the inert gas cylinder 78 or a voltage level of the battery 96, for example.

An actuator/valve assembly 106 may be used to open the inert gas cylinder 78. The actuator/valve assembly 106 may be a valve which is opened and closed by an actuator, which may be solenoid, pneumatic, pulley cable, lever or any other type of actuator or actuation device known in the art. Other electrical and/or mechanical actuators may be used, such as an emergency lever 110 installed on the outside of the oxygen absorber unit 76. The emergency lever 110 provides a mechanical connection 112 to activate the actuator/valve assembly 106.

Line 108 connects the control module 94 to the actuator/valve assembly 106. When the control module 94 receives a command from the controller 14 to activate the oxygen absorber system 70, the control module 94 sends a signal, such as a predetermined voltage level, over the line 108 to the actuator/valve assembly 106. Optionally, when the control module 94 activates the oxygen absorber system 70, the control module 94 may also activate one or both of a strobe 114 and horn 116 located on the outside of the oxygen absorber unit 76.

When the actuator/valve assembly 106 is activated, inert gas is released from the inert gas cylinder 78 through cylinder outlet 120. The cylinder outlet 120 may be directed into a hose, pipe or other conduit 122 connected to or directed at the absorbing material 80. The flow of the pressurized gas may be used to break the seals 90 and 91 that seal the oxygen absorbing material 80 from ambient air. The inert gas flows through the oxygen absorbing material 80 and out the absorber outlet 118 to the outlet conduit 86. Optionally, the cylinder outlet 120 may direct the flow of inert gas directly to the outlet conduit 86 without using conduit 122.

The power or kinetic energy of the pressurized gas drives the ambient room air through the air inlet 88, into the oxygen absorber unit 76 and into and through the oxygen absorbing material 80. Also, a slight positive pressure is initially created within the enclosed space 72 by the addition of the inert gas. The oxygen absorbing material 80 absorbs oxygen from the ambient air. The oxygen-reduced air mixes with the inert gas, is output through the absorber outlet 118 and flows through the outlet conduit 86 and into the enclosed space 72. The movement of air may be assisted by use of a fan, turbine, or other device (not shown) which is discussed further below.

The oxygen absorber system 70 simultaneously absorbs oxygen at a first rate and adds inert gas at a second level or rate which is designed to balance the volume of removed oxygen while maintaining the volume of air, and thus the air pressure, within the enclosed space 72. Compared to system configurations which only pump in large volumes of inert gas, the system configuration of FIG. 2 needs only 6% to 8% of inert gas per volume, creating a tremendous savings on both volume and storage of inert gas.

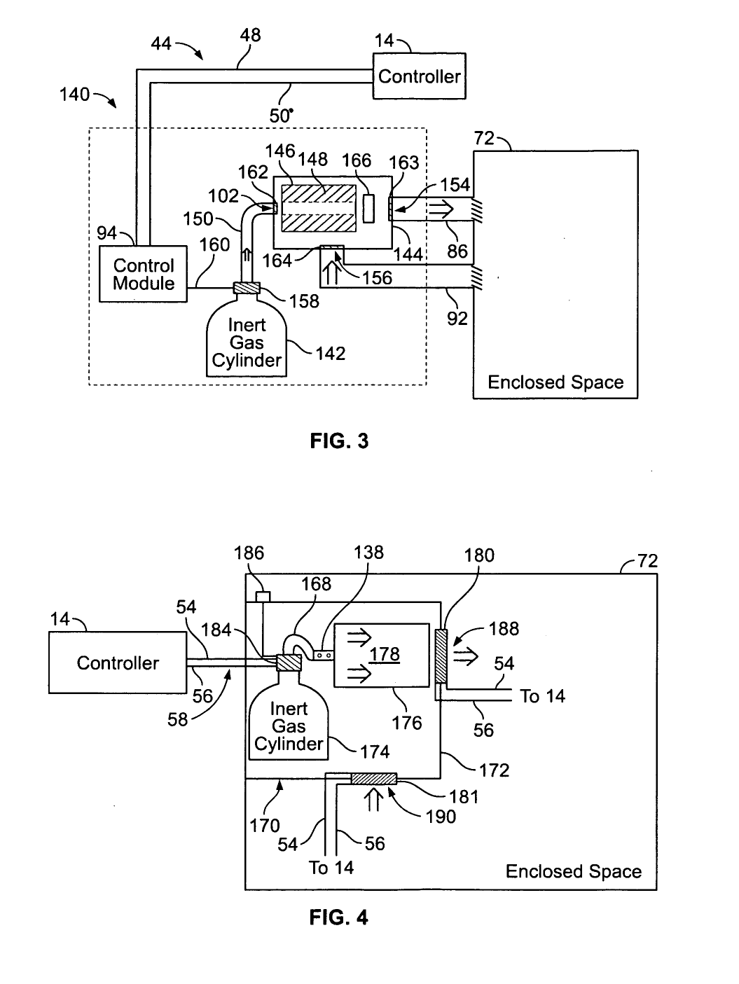

FIG. 3 illustrates an oxygen absorber system 140 wherein an inert gas cylinder 142 is held at a location away from an oxygen absorber unit 144 and the enclosed space 72. A housing 146 may be provided to secure and/or protect the oxygen absorbing material 148. The housing 146 and oxygen absorbing material 148 are illustrated as installed outside the enclosed space 72, but may instead be installed partially or fully within the enclosed space 72.

Air outlet 154 and air inlet 156 are provided in the oxygen absorber unit 144 and are connected to the outlet and inlet conduits 86 and 92, respectively, as previously discussed in FIG. 2. Gas inlet 102 receives inert gas conveyed through a pipe or conduit 150 from the inert gas cylinder 142. Seals 162, 163 and 164 are provided proximate the gas inlet 102, air outlet 154 and air inlet 156, respectively, to seal the oxygen absorbing material 148 from ambient air. The seals 162, 163, and 164 may be puncturable or be blown off by a predetermined pressure differential, may be a valve that opens at a predetermined pressure differential, or other method of removable seal.

Control module 94 receives commands from the controller 14 (FIG. 1) over the lines 48 and 50, such as over the network 44, and controls the inert gas cylinder 142 over line 160. In some configurations, it may be advantageous to locate all inert gas cylinders and associated control module(s) for an area, such as a floor of a building, in one location. For example, the inert gas cylinder 142 may be located up to 200 feet from the oxygen absorbing unit 144. In addition, the control module 94 may be used to control multiple inert gas cylinders (not shown) which protect different enclosed spaces.

Alternatively, the control module 94 may not be used and the inert gas cylinder 142 may be controlled directly by the controller 14. In other words, the oxygen absorber system 140 may be non-addressable, such as the oxygen absorber systems 52 on the network 58 (FIG. 1). Therefore, the lines 54 and 56 of the network 58 may be directly connected to actuator/valve assembly 158 of the inert gas cylinder 142.

When the actuator/valve assembly 158 is commanded to open over line 160 or is opened manually, inert gas is released from the inert gas cylinder 142, flows through the conduit 150, and breaks or opens the seal 162 at the gas inlet 102 of the oxygen absorber unit 144. Alternatively, if the seal 162 is accomplished by a valve or flap, the seal 162 may be commanded open by the control module 94. At the same time, the seals 163 and 164 may be broken by the pressure created by the inert gas flowing into the oxygen absorber unit 144 or may be commanded open by the control module 94.

The inert gas enters the oxygen absorber unit 144, flows through the oxygen absorbing material 148, out the air outlet 154, through the outlet conduit 86 and into the enclosed space 72. Pressure increases slightly in the enclosed space 72, and ambient air is pulled through the inlet conduit 92 and the air inlet 156. The oxygen absorbing material 148 absorbs oxygen from the ambient air. Oxygen-reduced air is then discharged out of the air outlet 154 with the inert gas. Alternatively, the flow of pressurized inert gas may be used to turn or power a fan 166 to pull or suck additional ambient air through the inlet conduit 92 and air inlet 156. Alternatively, the fan 166 may be powered by an electric power source. The position of the fan 166 is not limited to the illustrated position.

FIG. 4 illustrates an alternative oxygen absorber system 170 installed within the enclosed space 72. The oxygen absorber system 170 may similarly be installed partially within or completely outside the enclosed space 72. The oxygen absorber system 170 may not be addressable and therefore all oxygen absorber systems installed on the network 58 may be activated at the same time.

Oxygen absorber unit 172 holds an inert gas cylinder 174 and oxygen absorbing material 178, which may be held within a housing 176. The controller 14 connects directly to actuator/valve assembly 184 via lines 54 and 56 to control the opening of the inert gas cylinder 174. A manual release 186 provides manual control of the actuator/valve assembly 184, and may be mounted within the oxygen absorber unit 172 or on an outer surface of the oxygen absorber unit 172. The oxygen absorber unit 172 has an air outlet 188 for outputting inert gas and oxygen-reduced air, and at least one ambient air inlet 190. The air outlet 188 and air inlet 190 are sealed from outer ambient air by one or more seals 180 and 181. The seals 180 and 181 may be valves, flaps or other electrical or mechanical devices which may be actuated by the controller 14, by the flow of the pressurized gas, or by a pressure differential.

To activate the oxygen absorber system 170, the controller 14 sends a command signal out on the lines 54 and 56 to open the actuator/valve assembly 184 and to actuate the seals 180 and 181 to open the air outlet 188 and air inlet 190. Inert gas is released from the inert gas cylinder 174, flows into a hose, tube or pipe 168 and into a venturi tube 138. The venturi tube 138 is formed of a tube with holes therein and a small inner diameter, creating a pressure within the venturi tube 138 that is greatly reduced compared to the surrounding air pressure. As the inert gas flows through the venturi tube 138, the negative pressure draws air into the venturi tube 138 through the holes. Ambient air mixes with inert gas and is output through the air outlet 188 and into the enclosed space 72. Ambient air is pulled into the oxygen absorber unit 172 through the air inlet 190.

The oxygen absorber system 170 may require a greater quantity of the compressed inert gas to drive the system 170 compared to the systems of FIGS. 1-3. Optionally, a fan or more than one venturi tube 138 may be used to increase the flow of ambient air through the system 170.

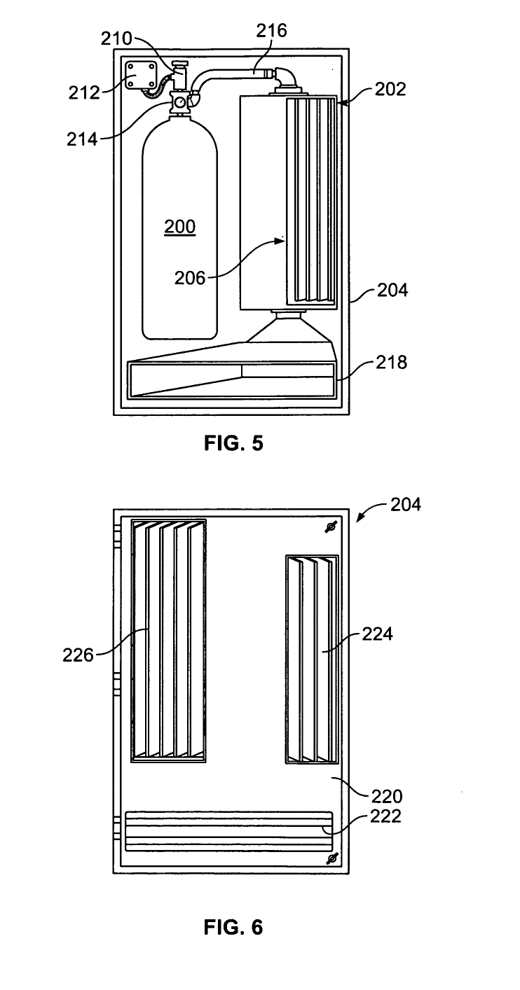

FIG. 5 illustrates a view of an inert gas cylinder 200 and absorber housing 202 inside oxygen absorber unit 204. The absorber housing 202 may have louvers or vents 206 therein allowing the ambient air to contact the oxygen absorbing material within (not shown). An actuator or actuator/valve assembly 210 is connected to an electrical terminal box 212 which receives the lines 54 and 56 from the controller 14 (FIG. 1). The inert gas cylinder 200 may have a pressure gauge 214 for displaying the pressure of the inert gas held therein. A hose or conduit 216 provides a connection between the inert gas cylinder 200 and the absorber housing 202.

FIG. 6 illustrates a view of the outside of the oxygen absorber unit 204 of FIG. 5. The oxygen absorber unit 204 may have a door 220 allowing access to the inert gas cylinder 200 and absorber housing 202. The door 220 has air outlet louvers 222 which correspond to the absorber outlet 218. Air intake louvers 224 in the door 220 provide an inlet for the ambient air outside the oxygen absorber unit 204, and air outlet louvers 226 provide an outlet for the oxygen-reduced air.

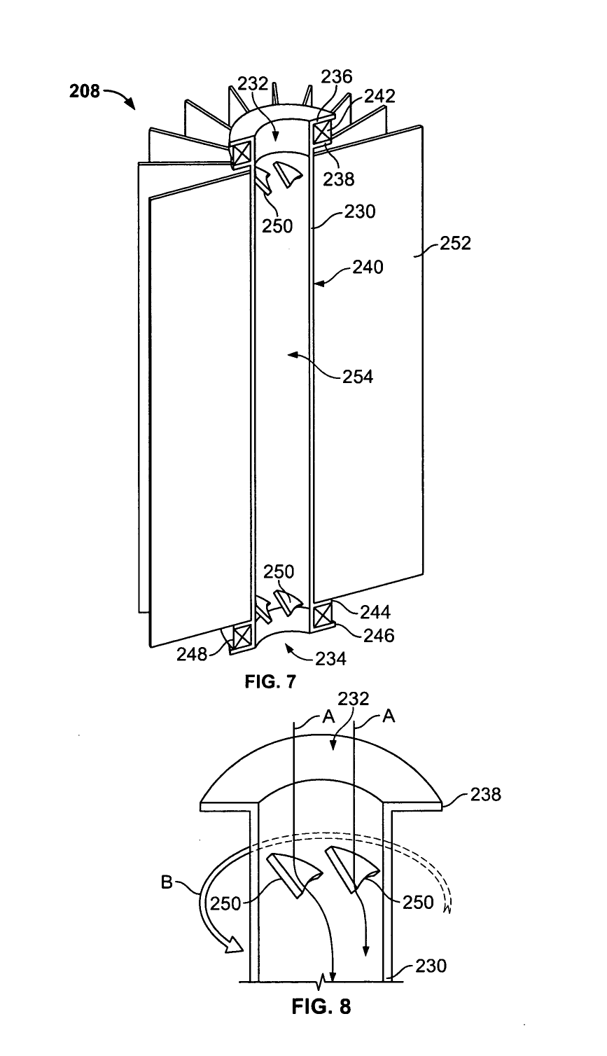

FIG. 7 illustrates a cut-away view of a rotatable structure 208 within of the absorber housing 202 of FIG. 5. A hollow shaft 230 is formed having inert gas inlet 232 and inert gas outlet 234. First and second lips 236 and 238 extend outwardly from an outer surface 240 of the shaft 230 proximate the inert gas inlet 232 to hold a first bearing 242 there-between. Third and fourth lips 244 and 246 extend outwardly from the outer surface 240 proximate the inert gas outlet 234 and hold a second bearing 248 there-between. The first and second bearings 242 and 248 allow the shaft 230 to rotate or turn.

Outer blades 252 extend outwardly from the outer surface 240 and may extend along a length of the shaft 230. The outer blades 252 may be coated or embedded with an oxygen absorbing material. Alternatively, the outer blades 252 may be formed of a honeycomb shape. The size and number of outer blades 252 extending from the shaft 230 may be determined by a desired surface area based on how much oxygen is to be absorbed. Inner blades 250 extend inwardly from an inner surface 254 of the shaft 230. The inner blades 250 may be formed proximate the inert gas inlet 232 and the inert gas outlet 234.

FIG. 8 illustrates a cut-away view of a portion of the shaft 230 of FIG. 7. The shaft 230, second lip 238 and inner blades 250 are indicated proximate the inert gas inlet 232. The inert gas flows into and through the shaft 230 in the direction of arrows A. The inert gas passes through the inner blades 250, causing the shaft 230 to turn in the direction of arrow B.

Referring to FIGS. 5-8, the pressure of the inert gas discharged through the conduit 216 may break seals (not shown) that seal the oxygen absorbing material from ambient air. The inert gas flows through the oxygen absorbing material in absorber housing 202 and out through absorber outlet 218. Pressure outside the housing 204 is increased, and ambient air is pulled into the housing 204 through air intake louvers 224. The shaft 230 turns to help pull the ambient air in while the oxygen absorbing material on the outer blades 252 absorbs oxygen from the ambient air. Oxygen-reduced air is then output through the air outlet louvers 226. Although a single rotatable structure 208 is discussed, it should be understood that more than one rotatable structure 208 may be used. Optionally, a fan (not shown) may be included within the oxygen absorber unit 204. The fan may be positioned to be driven by the flow of compressed inert gas or powered by a power source included within or proximate the oxygen absorber unit 204 or supplied over a network. The fan may increase the flow of ambient air within the system, and therefore minimize the quantity of inert gas needed.

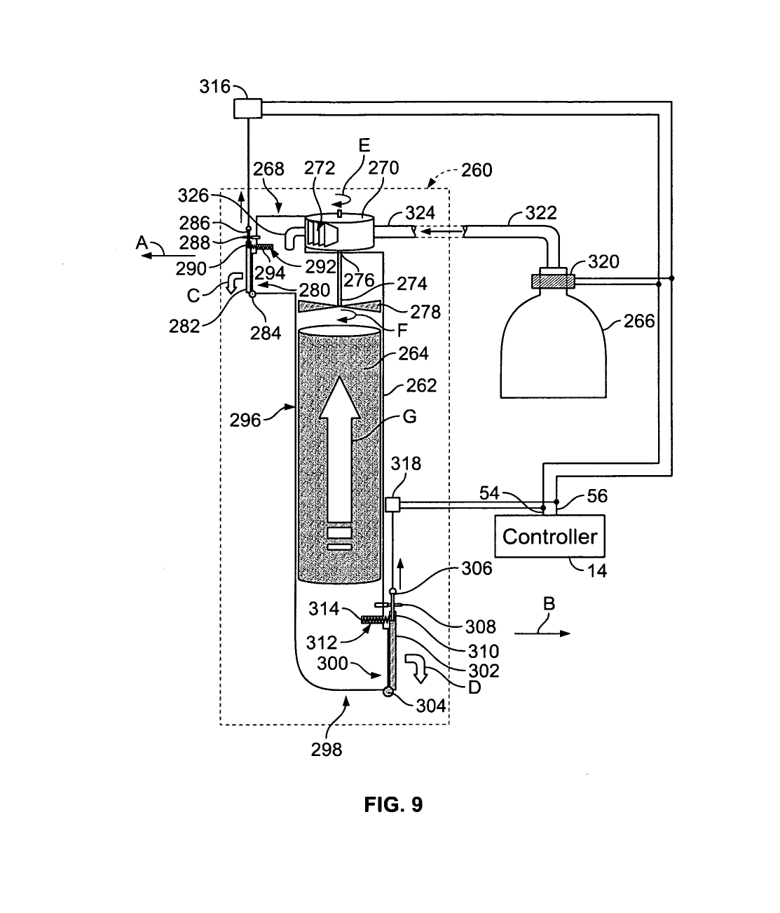

FIG. 9 illustrates an oxygen absorber system 260 having absorber housing 262 with oxygen absorbing material 264 held therein. The oxygen absorber system 260 may be installed within the enclosed space 72 (FIGS. 2 and 3). Inert gas cylinder 266 may be within, or located remote from, the enclosed space 72.

The oxygen absorbing material 264 may be a honeycomb structure, for example, which allows air to be pulled through. The oxygen absorbing material 264 is located between first and second ends 268 and 298 of the absorber housing 262. At the first end 268 of the absorber housing 262, a turbine 270 has blades 272 and is connected to a shaft 274 which extends through an airtight opening 276 in the absorber housing 262. Propeller blades 278 are mounted on the shaft 274 within the absorber housing 262.

Also proximate the first end 268, an air outlet 280 is formed in the absorber housing 262. The air outlet 280 is sealed with a seal 282, which may form a flap with hinge 284. Securing pin 286 may be inserted through a ring 288 extending from an outer surface 296 of the absorber housing 262 and into a hole 290 in the seal 282. A cavity 292 is formed in the outer surface 296 of the absorber housing 262 to retain a spring 294. The spring 294 exerts a force on the seal 282 in the direction of arrow A, while the securing pin 286 retains the seal 282 against the absorber housing 262, preventing ambient air from entering the absorber housing 262.

At the second end 298 of the absorber housing 262, an air inlet 300 is formed in the absorber housing 262. The air inlet 300 is sealed with seal 302, which may form a flap with hinge 304. Securing pin 306 may be inserted through a ring 308 extending from the outer surface 296 of the absorber housing 262 and into hole 310 in the seal 302. A cavity 312 is formed in the outer surface 296 to retain spring 314. The spring 314 exerts a force on the seal 302 in the direction of arrow B, while the securing pin 306 retains the seal 302 against the absorber housing 262, preventing ambient air from entering the absorber housing 262.

To activate the oxygen absorber system 260, the controller 14 sends a signal to one or more actuating components 316 and 318 which pull the securing pins 286 and 306, respectively. When the securing pin 286 is removed from the hole 290 in the seal 282, the force of the spring 294 pushes the seal 282 in the direction of arrow A. The seal 282 falls in the direction of arrow C, opening the air outlet 280. The seal 282 is retained by the hinge 284. The seal 302 is released in a similar manner to open the air inlet 300. The seal 302 falls in the direction of arrow D and is retained by the hinge 304.

The controller 14 also sends a signal to actuator/valve assembly 320 which opens the inert gas cylinder 266. Inert gas flows into a pipe or hose 322 and into inert gas inlet 324 of the turbine 270. The pressurized gas flow drives the turbine 270 in the direction of arrow E and thus turns the shaft 274 and propeller blades 278 in the direction of arrow F.

The inert gas leaves the turbine 270 through inert gas outlet 326, and flows out of the absorber housing 262 through air outlet 280. Positive pressure is created outside the absorber housing 262. The propeller blades 278 increase the ambient airflow into the air inlet 300 and through the oxygen absorbing material 264 in the direction of arrow G. The oxygen-reduced air mixes with the inert gas and flows out the air outlet 280.

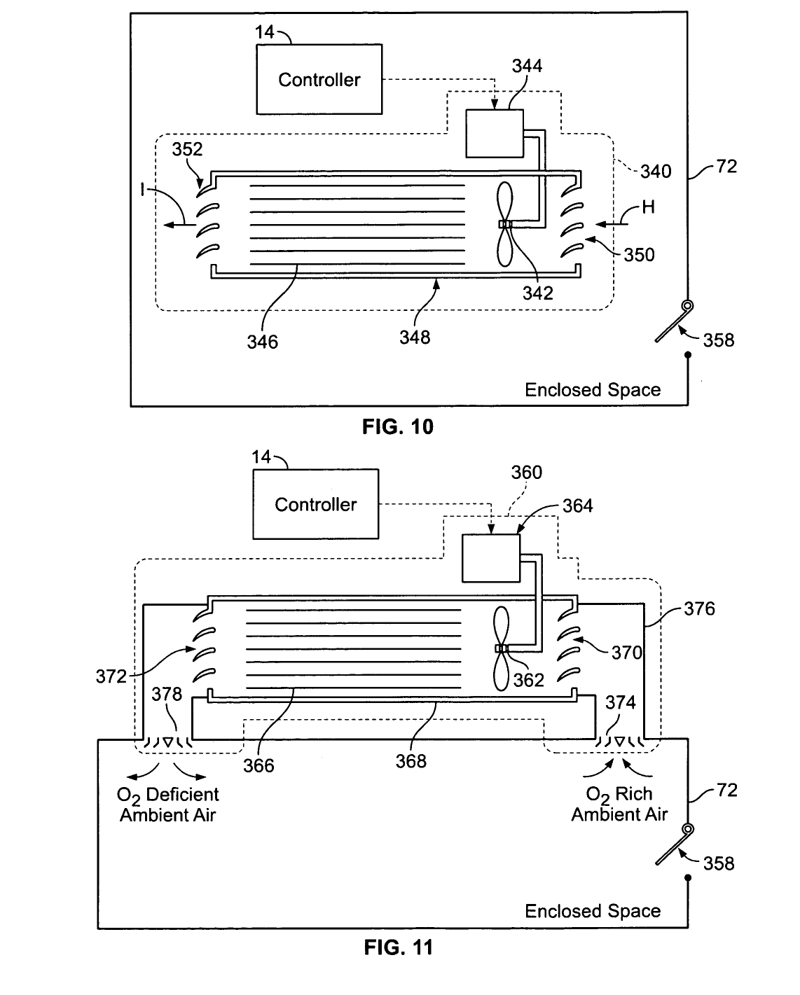

As discussed previously, oxygen absorber systems may be configured to operate without the use of pressurized inert gas and without adding inert gas to the enclosed space 72. FIG. 10 illustrates an oxygen absorber system 340 installed within the enclosed space 72. The controller 14 drives a fan 342, such as through fan controller 344. Oxygen absorbing material 346 is held within housing 348 which has an inlet seal 350 and an outlet seal 352 at opposite ends thereof. The fan may be externally driven, receiving power from the system 10 (FIG. 1).

When a fire alarm is received, the fan 342 is electrically operated. The inlet and outlet seals 350 and 352 are opened either by air pressure due to the fan 342, or may be electrically or mechanically operated, opened or removed as previously discussed. Ambient air flows through the housing 348 in the direction of arrow H. The oxygen absorbing material 346 absorbs oxygen, and oxygen-reduced air flows out of the housing 348 in the direction of arrow I. Negative pressure is experienced within the enclosed space 72 as the volume of oxygen is reduced. One or more pressure vents 358 may open to allow external air to flow into the enclosed space 72. The controller 14 may operate the fan 342 for a predetermined time and then stop. When the fan stops, the room pressure is restored to normal and outside air is no longer pulled into the enclosed space 72.

FIG. 11 illustrates an oxygen absorber system 360 installed outside the enclosed space 72. The controller 14 may drive a fan 362 through fan controller 364, as discussed in FIG. 10. Oxygen absorbing material 366 is held within housing 368 which has inlet and outlet seals 370 and 372. By way of example, the oxygen absorber system 360 may be installed within existing HVAC ducts in a building. Ambient air is pulled from the enclosed space 72 through a first vent 374 or other opening and into a duct 376. The oxygen absorbing material 366 absorbs oxygen, and oxygen-reduced air flows out of the housing 368, into the duct 376, and into the enclosed space 72 through second vent 378.

As discussed previously, oxygen absorber systems are designed to reduce the oxygen concentration from approximately 21% to approximately between 15% to 13%, which is a level that extinguishing fire and does not support combustion. The oxygen absorber systems that do not add inert gas may be designed to absorb a larger amount of oxygen, such as 7.525% of the oxygen content to compensate for additional oxygen brought in from outside the enclosed space 72, while oxygen absorber systems which use inert gas may be designed to absorb a lesser amount of oxygen, such as 6% of the oxygen content. With either type of system configuration, the enclosed space 72 is neither over-pressurized nor under-pressurized.

While the invention has been described in terms of various specific embodiments, those skilled in the art will recognize that the invention can be practiced with modification within the spirit and scope of the claims.

What is claimed is:

1. An oxygen absorbing fire suppression system, comprising:
oxygen absorbing material for absorbing oxygen from ambient air within an enclosed space;
a housing preventing the oxygen absorbing material from exposure to the ambient air outside the housing, the housing having at least one opening for exposing the oxygen absorbing material to the ambient air;
at least one seal provided proximate the at least one opening to prevent the oxygen absorbing material from exposure to the ambient air; and
an actuating component for removing at least a portion of the at least one seal to expose the oxygen absorbing material to the ambient air, the oxygen absorbing material being configured to lower an oxygen concentration within the enclosed space to a level that extinguishes fire.

2. The system of claim 1, the at least one opening further comprising an air inlet and an air outlet, the at least one seal further comprising first and second seals provided proximate the air inlet and the air outlet, respectively, to prevent the oxygen absorbing material from exposure to the ambient air, the actuating component releasing the first and second seals to open the air inlet and the air outlet to expose the oxygen absorbing material to the ambient air.

3. The system of claim 1, wherein the oxygen absorbing material is configured to absorb oxygen at a first rate, the system further comprising:
an inert gas cylinder holding inert gas under pressure; and
an actuator/valve assembly interconnected with the inert gas cylinder, the actuator/valve assembly releasing a pressurized gas flow of inert gas into the enclosed space at a second rate configured to replace the oxygen being absorbed at the first rate.

4. The system of claim 1, further comprising a container holding an inert gas under pressure and configured to supply the inert gas to the enclosed space, the container being located at one of within the enclosed space, remote from the enclosed space, and proximate the housing.

5. The system of claim 1, wherein the oxygen absorbing material has a surface area based on at least one of a volume of air within the enclosed space, a rate of a pressurized gas flow of inert gas provided to the enclosed space, a volume of an inert gas provided to the enclosed space, a rate at which oxygen absorption is desired, and a final percentage of oxygen desired within the enclosed space.

6. The system of claim 1, further comprising a fan blowing the ambient air through the housing, the oxygen absorbing material absorbing oxygen from the ambient air.

7. The system of claim 1, further comprising:
an inert gas cylinder holding inert gas under pressure;
an actuator/valve assembly interconnected with the inert gas cylinder, the actuator/valve assembly releasing a pressurized gas flow of inert gas from the inert gas cylinder, the pressurized gas flow entering the housing through the at least one opening; and
a fan driven by the pressurized gas flow, the fan pulling the ambient air into the housing through the at least one opening.

8. The system of claim 1, further comprising:
a fan pulling ambient air through the at least one opening of the housing; and
a controller turning the fan on for a predetermined amount of time, the controller turning the fan off after the predetermined amount of time.

9. A method for extinguishing a fire within an enclosed space, comprising:
providing oxygen absorbing material within a housing, the housing having at least one opening provided with a seal, the housing and seal preventing the oxygen absorbing material from exposure to ambient air within an enclosed space;
opening the at least one opening within the housing to expose the oxygen absorbing material to the ambient air within the enclosed space; and
absorbing oxygen from the ambient air within the enclosed space with the oxygen absorbing material, the oxygen absorbing material being configured to lower an oxygen concentration within the enclosed space to a level that extinguishes fire.

10. The method of claim 9, wherein the at least one opening further comprises an air inlet and an air outlet, the opening step further comprising opening the air inlet and the air outlet, the method further comprising pulling the ambient air from the enclosed space into the housing through the air inlet, the ambient air contacting the oxygen absorbing material to form oxygen-reduced air, the oxygen-reduced air flowing to the enclosed space through the air outlet.

11. The method of claim 9, further comprising blowing a pressurized gas flow of inert gas into the at least one opening, the pressurized gas flow pulling the ambient air into the at least one opening from the enclosed space.

12. The method of claim 9, further comprising:
absorbing oxygen from the ambient air within the enclosed space at a first rate; and
supplying an inert gas to the enclosed space at a second rate based on the first rate.

13. The method of claim 9, further comprising:
turning on a fan for a predetermined amount of time, the fan pulling ambient air into the housing from the enclosed space; and
turning the fan off after the predetermined amount of time.

14. A system for replacing oxygen with an inert gas within an enclosed space, comprising:
oxygen absorbing material for absorbing oxygen from ambient air within an enclosed space;
an oxygen absorber unit holding the oxygen absorbing material, the oxygen absorber unit having an air inlet allowing ambient air to enter the oxygen absorber unit and an air outlet for outputting oxygen-reduced air, wherein the air inlet and the air outlet are interconnected with the enclosed space;
means for preventing the ambient air and the oxygen absorbing material from being in contact with one another; and
means for pulling ambient air into the oxygen absorber unit through the air inlet from the enclosed space, the oxygen absorbing material being configured to lower an oxygen concentration within the enclosed space to a level that extinguishes fire.

15. The system of claim 14, further comprising:
a pressurized gas flow of inert gas; and
means for delivering the pressurized gas flow of inert gas to the air inlet.

16. The system of claim 14, further comprising:
first and second flaps for sealing the air inlet and the air outlet, respectively; and
an actuating component releasing the first and second flaps to open the air inlet and the air outlet to expose the oxygen absorbing material to the ambient air.

17. The system of claim 14, wherein the oxygen absorbing material coats at least one of a honeycomb structure and blades.

18. The system of claim 14, further comprising:
at least one of a controller and a control module receiving an oxygen absorber unit activation signal; and
actuating means for exposing the oxygen absorbing material to ambient air, the at least one of a controller and a control module activating the actuating means after receiving the oxygen absorber unit activation signal.

19. The system of claim 14, further comprising:
a pressurized gas flow of inert gas; and
a fan driven by the pressurized gas flow, the fan pulling the ambient air into the oxygen absorber housing through the air inlet.

20. The system of claim 14, further comprising a fan configured to pull ambient air into the oxygen absorber unit.
